(19) United States
(12) Patent Application Publication
(10) Pub. No.: US 2002/0161725 A1
(43) Pub. Date: Oct. 31, 2002

(54) Repair parts ordering and receipt inspection system

(75) Inventor: Kazuhisa Hoshi, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA GIKEN KOGYO KABUSHIKI KAISHA

(21) Appl. No.: 10/131,223

(22) Filed: Apr. 25, 2002

(30) Foreign Application Priority Data
Apr. 26, 2001 (JP) P.2001-128756

(51) Int. Cl. G06F 17/60; H04L 9/00; H04K 1/00

(52) U.S. Cl. 705/77

(57) ABSTRACT

A repair parts ordering and receipt inspection system has an ordering terminal installed in an ordering party of repair parts, a finished parts manufacturer terminal installed in a finished parts manufacturer from which finished parts of repair parts are ordered, and a material parts manufacturer terminal installed in a material parts manufacturer from which material parts of repair parts are ordered. The respective terminals are connected online. The ordering terminal classifies the repair parts into finished parts and material parts and issues orders to the finished parts manufacturer and the material parts manufacturer, respectively. When the material parts are delivered to the finished parts manufacturer, the material parts manufacturer terminal can input delivery information. When receipt inspection of the material parts is conducted, the finished parts manufacturer terminal can input receipt inspection information and can also perform payment processing.

### BACKGROUND OF THE INVENTION

1. Field of the Invention

This invention relates to a repair parts ordering and receipt inspection system and method. More particularly, the invention relates to an integrated and organized system and method for ordering repair parts that makes it possible to efficiently conduct ordering and receipt inspection of repair parts of automobiles.

2. Description of the Related Art

In the related art, ordering and receipt inspection management of repair parts is usually conducted using a single computer installed at an ordering party location, for example, the repair parts department of an automobile manufacturing company. Therefore, ordering of the repair parts from an order-receiving party (such as a parts manufacturer), the receipt inspection activities associated with receiving the repair parts, and the payment for the repair parts to the order-receiving party have been all managed by only the computer at the ordering party location. This process also may include, for example, keeping track of the number of repair parts containing defective pieces or the number of received repair parts versus the number of repair parts actually ordered.

Recently, the ordering party, the order-receiving parties, the distribution center, and the like have tended to be geographically located away from one another. Because of this physical separation, sometimes a large-scaled distribution center is constructed at a remote location to try to increase efficiency and reduce costs associated with the physical distribution of the repair parts.

The repair parts can include finished parts (for example, an entire carburetor) and/or material parts (for example, just the casing of the carburetor). In this case, the ordering party gives an order for material parts and then the finished parts manufacturer works on, assembles, etc., the material parts delivered from the material parts manufacturer to manufacture finished parts. The finished parts are then delivered to the distribution center, etc., of the ordering party.

Under such circumstances, if the material parts delivered to the finished parts manufacturer from the material parts manufacturer contain defective pieces, or the number of received parts was insufficient, in the related art, management of such defective material parts or insufficient number of received parts must also be conducted using the computer of the ordering party. Accordingly, a problem arises in that the management of this process by the ordering party becomes complicated, and consequently, the procurement time period of repair parts (time from ordering to delivery) is also prolonged.

### SUMMARY OF THE INVENTION

It is therefore an object of the invention to provide a repair parts ordering and receipt inspection system and method that can solve the above-mentioned problems, increase efficiency of the ordering and receipt inspection process, and shorten the procurement time period.

To that end, according to a first aspect of the invention, there is provided a repair parts ordering and receipt inspection system comprising an ordering terminal operable to order and process information regarding repair parts, the repair parts including at least one of finished parts and material parts, wherein the ordering terminal is further operable to order the finished parts from a finished parts manufacturer and the material parts from a material parts manufacturer;

a material parts terminal operable to receive requests for material parts and process information regarding the material parts, wherein the processing regarding the material parts includes at least one of maintaining inventory and delivery information of the material parts; and

a finished parts terminal operable to receive requests for finished parts and process information regarding the finished parts, wherein the processing regarding the finished parts includes maintaining receipt inspection information of delivered material parts,

wherein the ordering terminal, the finished parts terminal, and the material parts terminal are operable to communicate with one another.

The repair parts ordering and receipt inspection system according to a second aspect of the invention has a feature that the repair parts ordering and receipt inspection system according to the first aspect further comprises a receipt inspection terminal operable to process information regarding receipt inspection of the finished parts and perform payment processing based on the information regarding the receipt inspection of the finished parts, the receipt inspection terminal also operable to communicate with the ordering terminal, the finished parts terminal, and the material parts terminal.

The repair parts ordering and receipt inspection system according to a third aspect of the invention has a feature that in the repair parts ordering and receipt inspection system according to the first aspect, the ordering terminal includes a parts account information database operable to store and process repair part numbers and classification information of the repair parts, and an ordering account information database operable to store and process the repair part numbers and associated parts manufacturer information.

The repair parts ordering and receipt inspection system according to a fourth aspect of the invention has a feature that in the repair parts ordering and receipt inspection system according to the first aspect, the finished parts terminal performs payment processing to the material parts manufacturer.

Thus, the repair parts ordering and receipt inspection system according to the first aspect can provide the following advantages. First, when the material parts manufactured by the material parts manufacturer are delivered to the finished parts manufacturer, the delivery information including at least the parts number of the material parts and the number of the delivered material parts is entered into the material parts terminal installed in the material parts manufacturer from which the material parts of repair parts are ordered. When receipt inspection of the material parts delivered from the material parts manufacturer is conducted, the receipt inspection information including at least the part number of the material parts and the number of the parts subjected to the receipt inspection is entered into the finished parts terminal installed in the finished parts manufacturer from which the finished parts of repair parts are ordered. Thus, if the number of the delivered material parts is insufficient, the invention allows for immediately determining this deficiency and informing the material parts manufacturer of this fact through the network using the finished parts terminal and the material parts terminal. If defective pieces are identified, the invention also makes it possible to inform the material parts manufacturer of the fact, the reason for the defect, and the like in a similar manner. Further, the invention allows for the ordering party to know the circumstances online through the ordering terminal (if a receipt inspection terminal is provided according to the second aspect, then the receipt inspection terminal).

Therefore, if the material parts delivered to the finished parts manufacturer from the material parts manufacturer contain defective pieces or the number of the delivered material parts is insufficient, the repair parts ordering and receipt inspection system eliminates the need for the ordering party to manage the deficiency resolution process, simplifies the management job of the ordering party, and increases efficiency of ordering and receipt inspection jobs, resulting in shortening the procurement time period of the repair parts.

Moreover, the receipt inspection of the material parts is conducted by the finished parts manufacturer directly using the material parts, so that the advantage of improving the receipt inspection accuracy can also be provided.

According to the repair parts ordering and receipt inspection system according to the second aspect, the repair parts ordering and receipt inspection system according to the first aspect further includes a receipt inspection terminal installed in the receipt inspection site of the ordering party in addition to the ordering terminal. The receipt inspection terminal is connected to the ordering terminal online, wherein when receipt inspection of the finished parts delivered from the finished parts manufacturer is conducted, the receipt inspection terminal can input the receipt inspection information, so that receipt inspection of the finished parts is conducted at the receipt inspection site (for example, distribution center, etc.,) and the advantage of early conduct of receipt inspection can be provided.

When receipt inspection of the finished parts delivered from the finished parts manufacturer is conducted, the receipt inspection terminal can perform payment processing, so that the payment job can be executed smoothly and promptly.

According to the repair parts ordering and receipt inspection system according to the third aspect, in the repair parts ordering and receipt inspection system according to the first aspect, the ordering terminal includes a parts account information database operable to store and process repair part numbers and classification information of the repair parts, and an ordering account information database operable to store and process the repair part numbers and associated parts manufacturer information, so that the ordering management job of the repair parts can be executed reliably and smoothly.

According to the repair parts ordering and receipt inspection system according to the fourth aspect, in the repair parts ordering and receipt inspection system according to the first aspect, the finished parts terminal is a terminal which can perform payment processing to the material parts manufacturer, so that the finished parts manufacturer has the responsibility to directly pay for the material parts, and consequently, the payment job responsibilities for the ordering party are lightened.

A method of the invention for repair parts ordering and receipt inspection comprises:

maintaining at least one repair parts database including a repair parts account information database that categorizes the repair parts into at least one of material parts and finished parts;

issuing an order for repair parts based on the at least one repair parts database from at least one of a finished parts manufacturer and a material parts manufacturer, wherein

when the order requests material parts, the requested material parts are delivered from the material parts manufacturer to at least one of the finished parts manufacturer and the ordering party, and

when the order requests finished parts, the requested finished parts are delivered from the finished parts manufacturer to the ordering party;

performing receipt inspection of the delivered repair parts; and

during the ordering, delivery, and receipt inspection processes, updating and processing repair parts information in the at least one repair parts database and in compatible programs of terminals included at each of the finished parts manufacturer and the material parts manufacturer.

Thus, for the same reasons as those described above for the repair parts ordering and receipt inspection system, the method of the invention provides for increased efficiency of the ordering and receipt inspection process, and shortening the procurement time period.

### BRIEF DESCRIPTION OF THE DRAWINGS

FIG. 1 is a schematic diagram to show the configuration of one embodiment of a repair parts ordering and receipt inspection system according to the invention;

FIG. 2 is a job flowchart to describe the repair parts ordering and receipt inspection system according to the invention; and

FIG. 3 is a block diagram to show an outline of main sections.

### DETAILED DESCRIPTION OF THE PREFERRED EMBODIMENTS

Referring now to the accompanying drawings, description will be given of a preferred embodiment of the invention.

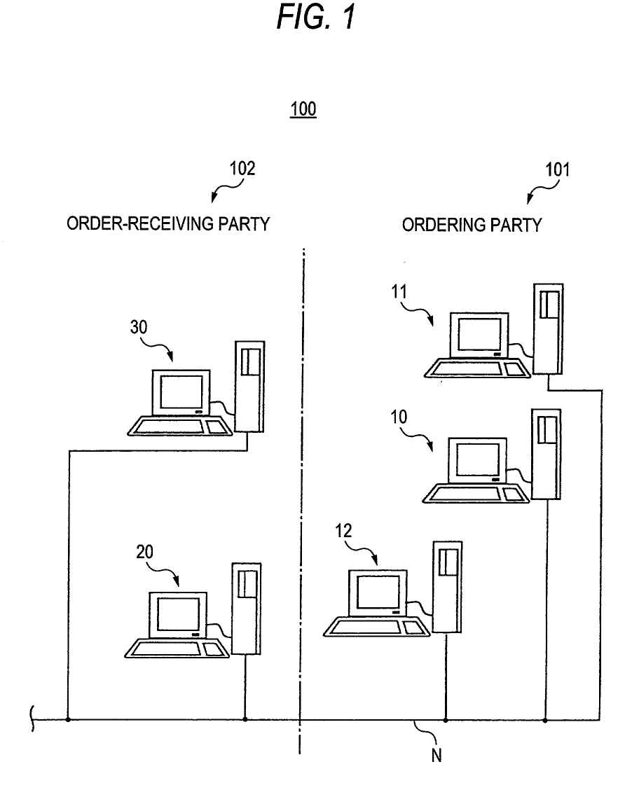

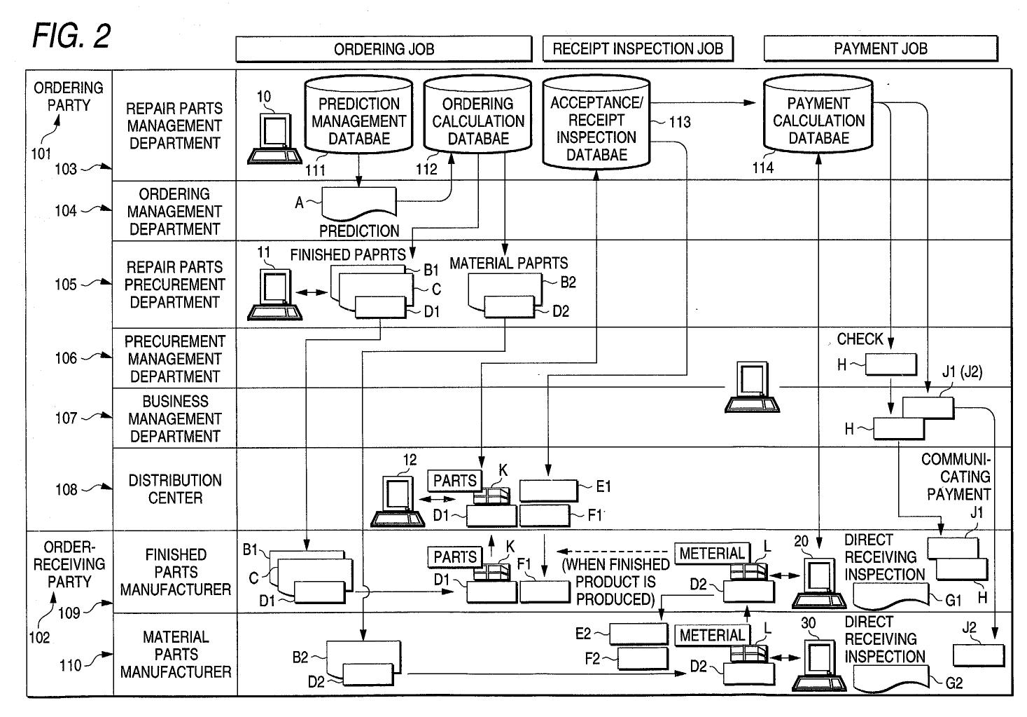

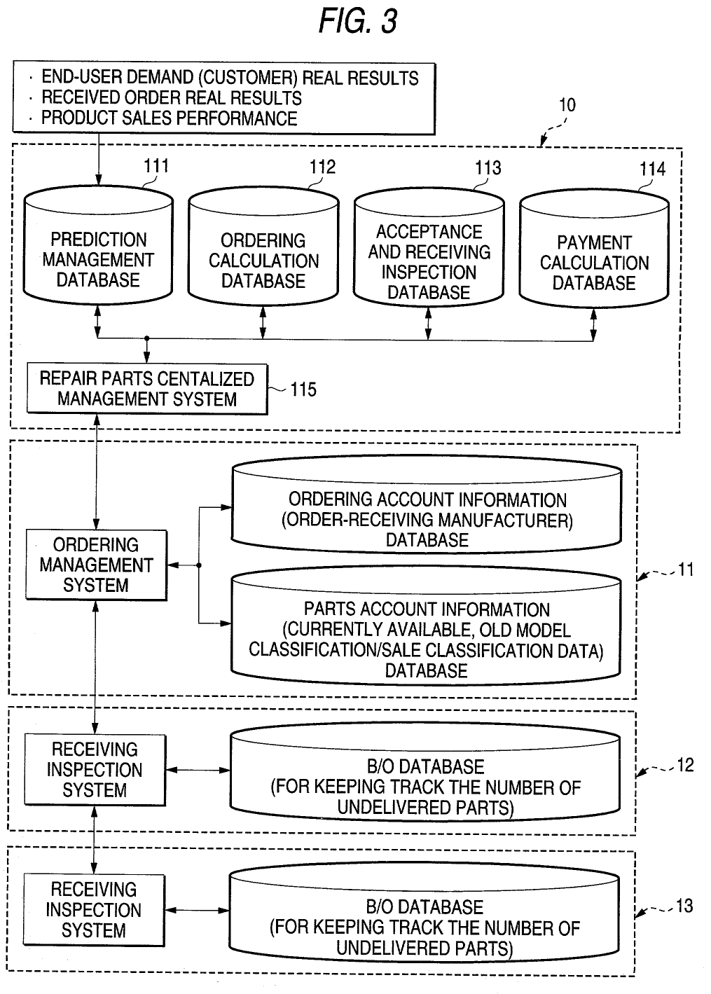

FIG. 1 is a schematic diagram to show the configuration of one embodiment of a repair parts ordering and receipt inspection system according to the invention. FIG. 2 is a non-limiting example of a job flowchart to describe the repair parts ordering and receipt inspection system and a method of the invention. In FIG. 2, depicted in the vertical direction are ordering parties (e.g., repair parts management department, ordering management department, repair parts procurement department, procurement management department, business management department, and distribution center) and order-receiving parties (e.g., finished parts manufacturer and material parts manufacturer). In the horizontal direction depicted in FIG. 2 are job contents (ordering job, receipt inspection job, and payment job). FIG. 3 is a block diagram to show an outline of main sections of the present invention.

As shown in the figures, the repair parts ordering and receipt inspection system 100 includes an ordering terminal 11 installed at an ordering party 101 location which is used to order repair parts, a receipt inspection terminal 12 installed at a receipt inspection site 108 (in this case, a distribution center) of the ordering party 101 aside from the ordering terminal 11, a finished parts manufacturer terminal 20 installed at a finished parts manufacturer 109 to which finished parts of repair parts are ordered, a material parts manufacturer terminal 30 installed in a material parts manufacturer 110 to which material parts of repair parts are ordered, and a host computer 10 for performing centralized management of data of all terminals. The host computer 10 and all terminals may be connected by a network (online N), such as the Internet, or wireless connection applications known in the art.

Each terminal may be implemented as a personal computer, for example. As known, the personal computer may include at least a CPU, a hard disk, an operation section such as a keyboard, a display, required software, and the like. The host computer 10 can also be implemented as a personal computer or server, for example.

The host computer 10 is placed in the repair parts management department 103 at the ordering party location (for example, an automobile manufacturer) in the embodiment. A prediction management database 111, an ordering calculation database 112, an acceptance and receipt inspection database 113, a payment calculation database 114, and a repair parts centralized management system 115 for manipulating the databases (DBs) are included in the hard disk of the host computer 10, as shown in FIGS. 2 and 3.

The prediction management database 111 is operable to predict the long-term and short-term demands for repair parts so as to keep a proper number of parts in stock at all times and also to determine the proper ordering time and the order quantity based on the predictions of the database 111. The prediction management database 111 may store the parts names and the parts numbers of the repair parts, the end-use demand results of the repair parts (sales performance for customers), the received order results for the repair parts from repair shops, the sales performance of finished products using the parts (for example, automobiles, motorcycles, etc.), and other data that may be used to effectively manage the ordering and receipt inspection process.

As shown in FIG. 2, the host computer 10 located in the repair parts management department 103 in this embodiment is operable to issue an order for material A to the ordering management department 104 based on the data in the prediction management database 111. Then the order for material A is evaluated by the ordering management department 104 and the evaluation result is transmitted to and reflected on the ordering calculation database 112. The order for material A and a parts order B1, a supplied parts list C, a delivery slip D1, a work instruction sheet E1, a receipt F1, a direct receipt inspection check table G1, an advance application list H, a delivery statement J1, etc., (described later) can be communicated as electronic data via the online N communications between the host computer 10 and each terminal 11, 12, 20, 30. Of course, the aforementioned data can also be printed out on paper on a printer, stored for future access, or transmitted via wireless communications to portable receiving devices, for example, PDAs.

The ordering calculation database 112 is provided for performing ordering calculation processing based on the ordering material evaluated by the ordering management department 104. As shown in FIG. 2, based on the ordering calculation database 112, the host computer 10 can issue a finished parts order B1, a supplied parts list C, and a delivery slip D1 to the finished parts manufacturer 109, and can issue a material parts order B2 and a delivery slip D2 to the material parts manufacturer 110. The orders, etc., can also be issued through the ordering terminal 11. In the embodiment, normally the orders, etc., are issued through the ordering terminal 11. If for some reason the ordering terminal 11 is unable to issue orders (for example, failure), the orders, etc., are issued by the host computer 10.

The supplied parts list C is a list of material parts to be supplied from the material parts manufacturer 110 to the finished parts manufacturer 109, and basically has the same contents as the order B2 issued to the material parts manufacturer 110. Since some finished parts manufacturers 109 finally assemble or work on material parts supplied from the material parts manufacturer 110 to the finished parts manufacturer 109, thereby producing finished parts as instructed by the ordering party 101 (for example, an automobile manufacturer), the finished parts manufacturer 109 is required to check on the contents of the supplied parts based on the supplied parts list C. Therefore, the supplied parts list C may sometimes not be issued.

The acceptance and receipt inspection database 113 is provided for performing acceptance and receipt inspection processing of repair parts. Based on the acceptance and receipt inspection database 113, the host computer 10 can issue both or either of a work instruction sheet E1 and a receipt F1, as shown in FIG. 2. The work instruction sheet E1 and the receipt F1 can also be issued through the receipt inspection terminal 12. In the embodiment, normally the work instruction sheet E1 and the receipt F1 are issued through the receipt inspection terminal 12. If for some reason the receipt inspection terminal 12 is unable to issue the work instruction sheet E1 or the receipt F1 (for example, failure), the orders, etc., are issued by the host computer 10.

If the delivered parts contain defective pieces, the work instruction sheet E1 informs the material parts manufacturer 110 of the reason of the defect and also the remedies, as applicable.

The payment calculation database 114 is provided for payment calculation processing to the appropriate repair parts manufacturer 109, 110. Based on the payment calculation database 114, the host computer 10 can issue an advance application list H and delivery statements J1 and J2, as shown in FIG. 2.

In the embodiment, the ordering terminal 11 is placed in the repair parts procurement department 105 in the ordering party. The ordering terminal 11, which is operated by a representative of the ordering party 101, is operable to classify repair parts into finished parts 116 and material parts 117 based on an ordering account information database 7 and a parts account information database 8 and can issue a finished parts order B1, a supplied parts list C, and a delivery slip D1 for the finished parts to the finished parts manufacturer 109 and a material parts order B2 and a delivery D2 for the material parts to the material parts manufacturer 110. The supplied parts list C is issued as required, as described above.

The ordering account information database 7, the parts account information database 8, and an ordering management system 6 that can manipulate the databases are built into or stored on the hard disk of the ordering terminal 11, as shown in FIG. 3.

As the information concerning the repair parts, at least one of the parts numbers and classification information of the repair parts are stored in the parts account information database 8.

The parts number is a unique number given to each repair part and may be, for example, a character string consisting of numeric and alphabetic characters, etc.

The classification information is application information of the repair parts. For example, if the repair parts are used in current models, they are classified into “currently available parts;” if the repair parts are used only with old models, they are classified into “old model parts;” if the repair parts are integrated into other similar parts, they are classified into “integrated parts,” and so on.

As an example, a case where a piston P1 of an engine of an automobile of model X1 is the repair part is discussed below.

If the piston P1 is used in a current automobile engine, the classification information of the repair part is “currently available parts”. If the piston P1 is used only with old model X0 of the automobile X1, the classification information of the repair part is “old model parts”. If the piston P1 is integrated into a piston P2 of an engine of an automobile X2, being another similar part, the classification information of the repair part is “integrated parts”.

Various types of classification information other than described above are available. For example, if the repair parts are parts of an overseas dedicated model and thus are not applied domestically, they are classified into “unapplied”; if production of the corresponding model is stopped and sale of parts is also stopped, they are classified into “sale stop”, and so on.

The present invention may also accommodate situations in which the classification information of the repair parts is changed.

For example, if the repair parts used only with old models become used also with a new model, the classification information of the repair parts must be changed from “old model parts” to “currently available parts.” If the repair parts classified into “unapplied” domestically because of overseas dedicated model parts become used with a new domestic model, the classification information of the repair parts must be changed from “unapplied” to “currently available parts”. Further, if the repair parts whose sale is also stopped because production of the corresponding model is stopped are integrated into other similar repair parts and consequently are again sold, the classification information of the repair parts must be changed from “sale stop” to “integrated parts”.

Therefore, the parts account information database 8 is designed so as to enable at least the classification information to be changed.

If the classification information is thus changed, the parts need to be distinguished according to the classification information, although they have the same parts name and thus the parts are given different numbers as the parts numbers. In such a case, the total number of parts identified by the parts numbers may reach to several million for an automobile.

As the information concerning repair parts, at least the parts numbers of the repair parts and the manufacturer information for each repair part are stored in the ordering account information database 7. The parts numbers are as described above.

The manufacturer information is the name of the manufacturer from which the repair parts are ordered, the code number assigned to the manufacturer, or the like. A situation in which the manufacturer information must be changed also often occurs.

For example, to change the parts manufacturer of the order-receiving party 102 in response to an increase or decrease in the production amount of the parts as the classification information is changed as described above, to change to a Z factory for producing the repair parts of a new model because the new model is produced in the Z factory although the old model is produced in a Y factory and thus, the repair parts are also produced therein, or to change to an overseas order-given party as the repair parts manufacturer or factory is relocated overseas, it becomes necessary to change the manufacturer information.

Therefore, like the parts account information database 8, the ordering account information database 7 is also designed so as to make it possible to change at least the manufacturer information of the party from which each part is ordered.

In the embodiment, the receipt inspection terminal 12 is placed in the distribution center 108 of the ordering party, as shown in FIG. 2. In receipt inspection of finished parts K delivered from the finished parts manufacturer 109, the receipt inspection terminal 12 can input the receipt inspection information and can also access the payment calculation database 114 and perform payment processing.

As the receipt inspection information, the finished parts manufacturer name, the material parts manufacturer name, the parts number, the order number, the receipt inspection date, the number of parts subjected to the receipt inspection, the excessive or insufficient number of parts, the reason if defective pieces are contained, and the like can be processed.

The finished parts manufacturer terminal 20 is placed in the finished parts manufacturer 109. In receipt inspection of material parts L delivered from the material parts manufacturer 110, a representative of the finished parts manufacturer can input the receipt inspection information into finished parts manufacturer terminal 20. The receipt inspection information is as described above.

The finished parts manufacturer terminal 20 is also operable to access the payment calculation database 114 and perform payment processing to the material parts manufacturer 110, as shown in FIG. 2.

Back order databases 10, 12 may be built in each of the receipt inspection terminal 12 and the finished parts manufacturer terminal 20, respectively as shown in FIG. 3. If already ordered and undelivered parts exist, the back order databases 10, 12 are provided for storing and processing the number of undelivered parts (the back order (B/O) number), and the parts name of the parts, the parts number, the manufacturer information, the number of already ordered parts, the back order number, and the like.

The material parts manufacturer terminal 30 is placed in the material parts manufacturer 110. To deliver material parts L to the finished parts manufacturer 109, a representative of the material parts manufacturer can input delivery information into the material parts manufacturer terminal 30 including the parts number of the material parts L and the number of the delivered material parts.

As the delivery information, the finished parts manufacturer name, the material parts manufacturer name, the parts number, the order number, the work classification, the delivery date, the number of delivered parts, and the like can be named.

The whole flow and method of the repair parts ordering and receipt inspection job using the repair parts ordering and receipt inspection system will be discussed as a non-limiting example with reference to FIG. 2.

(1) A representative of the repair parts management department 103 uses the host computer 10 to enter the end-use demand results of the repair parts (sales performance for customers), the received order results for the repair parts, the sales performance of finished products using the parts (in this case, automobiles, etc.), and the like into the prediction management database 111, and issues an order for material A to the ordering management department 104 periodically, such as daily, based on the data in the prediction management database 111. The order for material A is evaluated by the ordering management department 104 and the evaluation result is transmitted and reflected on the ordering calculation database 112 whenever necessary.

(2) The repair parts procurement department 105 uses the ordering terminal 11 to check the data in the ordering calculation database 112 periodically, such as daily. If repair parts need to be ordered, the repair parts procurement department 105 classifies the repair parts into finished parts 116 and material parts 117 based on the ordering account information database 7 and the parts account information database 8 and issues a finished parts order B1, a supplied parts list C, and a delivery slip D1 for the finished parts 116 to the finished parts manufacturer 109, and issues a material parts order B2 and a delivery slip D2 for the material parts 117 to the material parts manufacturer 110. The ordering account information database 7 and the parts account information database 8 are updated whenever necessary as described above.

(3) Upon receipt of the material parts order B2 and the delivery slip D2, the material parts manufacturer 110 manufactures the material parts L in response to the material parts order B2 and delivers the material parts L to the finished parts manufacturer 109.

At the time, the material parts manufacturer 110 enters the above-described delivery information into the material parts manufacturer terminal 30.

A direct receipt inspection check table G2 is prepared as required. The direct receipt inspection check table G2 is used for each manufacturer to check the actual performance and accuracy of the repair parts.

Necessary information is documented on the delivery slip D2, and the delivery slip D2 is transmitted to the finished parts manufacturer terminal 20 or is delivered together with the material parts L.

To deliver an incomplete number of the material parts L at a time, the data of the material parts is entered into the material parts manufacturer terminal 30 and a “new delivery slip” for the remaining number of parts relative to the order quantity (quantity described on the material parts order B2) is issued on the material parts manufacturer terminal 30.

(4) When the material parts L are delivered from the material parts manufacturer 110, the finished parts manufacturer 109 receiving the finished parts order B1, the supplied parts list C, and the delivery slip D1 uses the finished parts manufacturer terminal 20 to collate the supplied parts list C with the delivery slip D2 from the material parts manufacturer 110 and conducts receipt inspection of the material parts L. That is, whether or not the material parts L are proper and whether or not the quantity is insufficient are checked. If the quantity is insufficient, the insufficient number of material parts L (the back order number and if defective pieces are contained, the number of the defective pieces) is recorded in the back order database 12.

At this time, the finished parts manufacturer 109 enters the receipt inspection information through the finished parts manufacturer terminal 20. The receipt inspection information is as described above.

If the delivered material parts L contain defective pieces, a work instruction sheet E2 on which the reason and remedies are described is prepared on the finished parts manufacturer terminal 20 and is sent to the material parts manufacturer 110 (for example, to the material parts manufacturer terminal 30). If the material parts L do not contain any defective pieces, a receipt F2 (if the material parts L contain defective pieces, a receipt for the material parts L minus the defective pieces) is prepared on the finished parts manufacturer terminal 20 and is sent to the material parts manufacturer 110.

Further, the finished parts manufacturer 109 accesses the payment calculation database 114 through the finished parts manufacturer terminal 20 and performs payment processing to the material parts manufacturer 110. When the payment processing is performed, a delivery statement J2 is sent from the host computer 10 to the material parts manufacturer 110 and the payment is also communicated thereto.

(5) In response to the finished parts order B1, the finished parts manufacturer 109 assembles or works on the material parts L from the material parts manufacturer 110 (in the figure, only one material parts manufacturer is drawn; in fact, however, more than one material parts manufacturer may exist) to manufacture finished parts K, and delivers the finished parts K to the distribution center 108 of the ordering party 101.

At this time, the finished parts manufacturer 109 enters the above-described delivery information into the finished parts manufacturer terminal 20.

A direct receipt inspection check table G1 is prepared as required. The direct receipt inspection check table G1 is used for each manufacturer to check the actual performance.

Necessary information is documented in the delivery slip D1 and the delivery slip D1 is transmitted to the receipt inspection terminal 12 or is delivered together with the finished parts K.

To deliver an incomplete number of the finished parts K at a time, the data of the finished parts is entered into the finished parts manufacturer terminal 20 and a “new delivery slip” for the remaining number of parts relative to the order quantity (quantity described on the finished parts order B1) is issued on the finished parts manufacturer terminal 20.

(6) In the distribution center 108, when the finished parts K are delivered from the finished parts manufacturer 109, using the receipt inspection terminal 12, the finished parts order B1 prepared on the ordering terminal 11 is collated with the delivery slip D1 from the finished parts manufacturer, the acceptance and receipt inspection database 113 is accessed, and receipt inspection of the finished parts K is conducted. That is, whether or not the finished parts K are proper and whether or not the quantity is insufficient are checked. If the quantity is insufficient, the insufficient number of finished parts (the back order number and if defective pieces are contained, containing the number of the defective pieces) is entered into the back order database 10.

At this time, in the distribution center 108, the receipt inspection information is entered through the receipt inspection terminal 12. The receipt inspection information is as described above.

If the delivered finished parts K contain defective pieces, a work instruction sheet E1 on which the reason and remedies are described is prepared on the receipt inspection terminal 12 and is sent to the finished parts manufacturer 109 (for example, to the finished parts manufacturer terminal 20). If the finished parts K do not contain any defective pieces, a receipt F1 (if the finished parts K contain defective pieces, a receipt for the finished parts K minus the defective pieces) is prepared on the receipt inspection terminal 12 and is sent to the finished parts manufacturer 109.

Further, in the distribution center 108, the payment calculation database 114 is accessed through the receipt inspection terminal 12 and payment processing to the finished parts manufacturer 109 is performed. When the payment processing is performed, an advance application list H and a delivery statement J1 are sent from the host computer 10 to the finished parts manufacturer 109 and the payment is also transmitted thereto. The advance application list H and the delivery statement J may be processed by a procurement management department 106 and a business management department 107, respectively.

The repair parts ordering and receipt inspection system 100 described above can provide the following advantages:

(a) When the material parts L manufactured by the material parts manufacturer 110 are delivered to the finished parts manufacturer 109, the delivery information containing at least the parts number of the material parts L and the number of the delivered material parts L is entered into the material parts manufacturer terminal 30 installed in the material parts manufacturer 110 from which the material parts L of repair parts are ordered. When receipt inspection of the material parts L delivered from the material parts manufacturer 110 is conducted, the receipt inspection information containing at least the part number of the material parts L and the number of the parts subjected to the receipt inspection is entered into the finished parts manufacturer terminal 20 installed in the finished parts manufacturer 109 from which the finished parts K of repair parts are ordered. Thus, if the number of the delivered material parts L is insufficient, it is made possible to immediately determine this fact and inform the material parts manufacturer 110 of the fact through the network using the finished parts manufacturer terminal 20 and the material parts manufacturer terminal 30. If defective pieces are contained, it is also made possible to inform the material parts manufacturer 110 of the fact, the reason for the defect, and the like in a similar manner. Further, it is also made possible for the ordering party 101 to know the circumstances online through at least one of the ordering terminal 11, the receipt inspection terminal 12, and the host computer 10.

Therefore, if the material parts L delivered to the finished parts manufacturer 109 from the material parts manufacturer 110 contain defective pieces or the number of the delivered material L parts is insufficient, the repair parts ordering and receipt inspection system 100 eliminates the need for the ordering party 101 (repair parts management department, procurement department, distribution center, etc.,) to manage it, simplifies the management job of the ordering party 101, and increases efficiency of ordering and receipt inspection jobs, resulting in shortening the procurement time period of the repair parts.

Moreover, the receipt inspection of the material parts L is conducted by the finished parts manufacturer 109 directly using the material parts L, so that the advantage of improving the receipt inspection accuracy can also be provided.

(b) The repair parts ordering and receipt inspection system 100 may further include the receipt inspection terminal 12 installed in the receipt inspection site 108 of the ordering party 101 aside from the ordering terminal 11, the receipt inspection terminal 12 being connected to the ordering terminal 11 online, wherein when receipt inspection of the finished parts K delivered from the finished parts manufacturer 109 is conducted, a representative operating the receipt inspection terminal 12 can input the receipt inspection information, so that receipt inspection of the finished parts K is conducted in the receipt inspection site 108 (for example, distribution center, etc.) and the advantage of early conduct of receipt inspection can be provided.

When receipt inspection of the finished parts K delivered from the finished parts manufacturer 109 is conducted, the receipt inspection terminal 12 can perform payment processing, so that the payment job can be executed smoothly and promptly.

(c) The ordering terminal 11 is a terminal for issuing the orders based on the parts account information database 8 storing at least the part number and classification information of the repair parts and the ordering account information database 7 storing at least the part number of the repair parts and parts manufacturer information of the party from which each part is ordered, so that the ordering management job of the repair parts can be executed reliably and smoothly.

(d) The finished parts manufacturer terminal 20 is a terminal which can perform payment processing to the material parts manufacturer 110, so that it is made possible to directly pay for the material parts by the finished parts manufacturer's own responsibility and consequently, the payment job load for the ordering party 101 is lightened.

Although the invention has been described in its preferred embodiment, it is understood that the invention is not limited to the specific embodiment thereof and widely different embodiments of the invention may be made without departing from the spirit and scope thereof.

What is claimed is:

1. A repair parts ordering and receipt inspection system comprising:
an ordering terminal operable to order and process information regarding repair parts, the repair parts including at least one of finished parts and material parts, wherein the ordering terminal is further operable to order the finished parts from a finished parts manufacturer and the material parts from a material parts manufacturer;
a material parts terminal operable to receive requests for material parts and process information regarding the material parts, wherein the processing regarding the material parts includes at least one of maintaining inventory and delivery information of the material parts; and
a finished parts terminal operable to receive requests for finished parts and process information regarding the finished parts, wherein the processing regarding the finished parts includes maintaining receipt inspection information of delivered material parts,
wherein the ordering terminal, the finished parts terminal, and the material parts terminal are operable to communicate with one another.

2. The repair parts ordering and receipt inspection system according to claim 1, further comprising:
a receipt inspection terminal operable to process information regarding receipt inspection of the finished parts and perform payment processing based on the information regarding the receipt inspection of the finished parts, the receipt inspection terminal also operable to communicate with the ordering terminal, the finished parts terminal, and the material parts terminal.

3. The repair parts ordering and receipt inspection system according to claim 1, wherein the ordering terminal includes a parts account information database operable to store and process repair part numbers and classification information of the repair parts, and an ordering account information database operable to store and process the repair part numbers and associated parts manufacturer information.

4. The repair parts ordering and receipt inspection system according to claim 1, wherein the finished parts terminal is also operable to perform payment processing to the material parts manufacturer.

5. A method for repair parts ordering and receipt inspection comprising:
maintaining at least one repair parts database including a repair parts account information database that categorizes the repair parts into at least one of material parts and finished parts;
issuing an order for repair parts based on the at least one repair parts database from at least one of a finished parts manufacturer and a material parts manufacturer, wherein
when the order requests material parts, the requested material parts are delivered from the material parts manufacturer to at least one of the finished parts manufacturer and the ordering party, and
when the order requests finished parts, the requested finished parts are delivered from the finished parts manufacturer to the ordering party;
performing receipt inspection of the delivered repair parts; and
during the ordering, delivery, and receipt inspection processes, updating and processing repair parts information in the at least one repair parts database and in compatible programs of terminals included at each of the finished parts manufacturer and the material parts manufacturer.

6. The method for repair parts ordering and receipt inspection according to claim 5, wherein the at least one repair parts database further includes at least one of a prediction management database, an ordering calculation database, an acceptance and receipt inspection database, and a payment calculation database.

7. The method for repair parts ordering and receipt inspection according to claim 6, wherein the ordering process is initiated by the prediction management database based on a prediction of long and short term repair parts usage.

8. The method for repair parts ordering and receipt inspection according to claim 5, further including performing payment processing after receipt inspection to the corresponding finished parts manufacturer and material parts manufacturer.
